(19) United States
(12) Patent Application Publication
(10) Pub. No.: US 2005/0039067 A1
(43) Pub. Date: Feb. 17, 2005

(54) METHOD AND RELATED SYSTEM FOR DYNAMICALLY ADJUSTING OPERATIONAL FREQUENCY

(76) Inventors: Hon-Chen Tsau, Taipei Hsien (TW); Ting-Wen Chen, Taipei Hsien (TW); Yao-Nan Lin, Taipei Hsien (TW); Ming-Shan Tsai, Taipei Hsien (TW)

Correspondence Address: (NAIPC) NORTH AMERICA INTERNATIONAL PATENT OFFICE, P.O. BOX 506, MERRIFIELD, VA, 22116, US

(21) Appl. No.: 10/605,995

(22) Filed: Nov. 12, 2003

(30) Foreign Application Priority Data
Aug. 14, 2003 (TW) 092122319

(51) Int. Cl. G06F 1/04

(52) U.S. Cl. 713/600

(57) ABSTRACT

A method of dynamically adjusting an operational frequency of a digital processing device. The method includes the steps of selecting a frequency operational mode, setting a work range of operational frequency according to the frequency operational mode, and selecting an operational frequency within the frequency range for running the digital processing device.

### BACKGROUND OF INVENTION

1. Field of the Invention

The present invention relates to a method and a system for dynamically adjusting an operational frequency used in a digital processing device, and more specifically, to a method and a system for assigning a frequency range and thus for determining a proper operational frequency within the assigned frequency range to run the digital processing device.

2. Description of the Prior Art

With the technology advances, personal computers have become necessities for families. Due to the rapid development of video and audio techniques, three dimension (3D) programs have replaced conventional two dimension (2D) images as the popular image technique for use in personal computers, especially in PC games.

In order to attract user's eyesight, more and more vivid and fantastic 3D images are widely used in PC games. Some elaborate 3D programs are almost close to real life images. However, to display those 3D programs request lots of system resources to calculate data. If the system cant produce enough resources, it results either programs delay or lower quality, both being undesirable to the user.

As a result, over-clocking which means that a central processing unit (CPU) of the computer or a graphics processing unit (GPU) of a video graphics adapter (VGA) is operated over suggested frequency is a solution. For example, an Intel® Pentium 4 CPU marked 1.4 GHz being operated at 1.6 GHz indicates over-clocking. Generally speaking, the suggested operational frequency is a security value for long-term use. Therefore, some advanced users try to set a frequency value that is higher than the suggest one by 2% to 40%, even 75% to achieve a maximum performance of the computing system. However, the computing system that is over-clocke may be apt to be unstable, causing an unexpected shut down, a sudden interruption of an executed program, higher heat generation, and a shorter life of the computing device. Nevertheless, those situations don't happen necessarily.

Over-clocking can have more advantages than disadvantages, but it is complicated for common users to do over-clock their systems. The inventor of the present invention discloses a solution in Taiwan Patent No. 511027 to solve such complicated setting problems. One embodiment of that patent is a software program operated under the Windows environment, used for assigning an operational frequency at which the CPU can be operated. In this way, the user does not need to adjust a complex setting of BIOS, or frequency settings of a motherboard. Hence, the computing device will run according to the assigned frequency until another frequency is assigned. Statistically, higher resource requirements are only approximately 5-10% of the total time when a computer is used. It is not worthwhile for a user to select a higher frequency that it will make the computer system to take the risk of unstable.

### SUMMARY OF INVENTION

It is therefore a primary objective of the claimed invention to provide a method of automatically adjusting an operational frequency and related apparatus, in order to solve the above-mentioned problems.

It is therefore another objective of the claimed invention to provide a method of setting a variable frequency range and related apparatus.

According to the claimed invention, a method of dynamically adjusting an operational frequency of a digital processing device includes the steps of selecting a frequency operational mode, setting a range of operational frequencies according to the frequency operational mode, and selecting an operational frequency within the frequency range for running the digital processing device.

Moreover, according to the claimed invention, a system for dynamically adjusting an operational frequency of a digital processing device includes an interface unit for receiving an external command to assign a frequency operational mode; a setting unit, coupled to the interface unit, for setting a frequency range according to the frequency operational mode; and a processing unit, coupled to the setting unit, for selecting an operational frequency in the frequency range.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a flowchart of the present invention method.

FIG. 2 is a block diagram of the system according to the present invention.

FIG. 3 is a graph showing the manipulation interface used in a personal computer according to the present invention.

### DETAILED DESCRIPTION

The spirit of the present invention is that a processing device is capable of searching a proper operational frequency to be run from a predetermined or an assigned frequency range, according to its requirement. That is, the user can assign a frequency range to the processing device, so that the processing device can select the optimum within the assigned range.

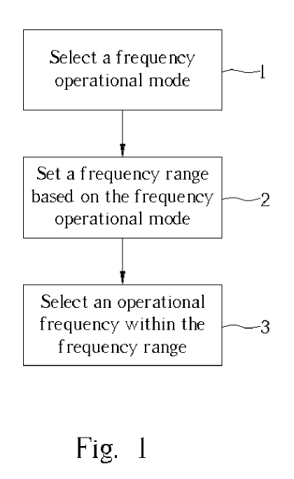

Please refer to FIG. 1. FIG. 1 is a flowchart of the present invention method. The present invention method can be performed in a digital processing device such as a central processing unit (CPU) or a graphics processing unit (GPU), so that the operational frequency of the digital processing device can be changed to adjust the processing speed of the digital processing device. The method occurs as follow:

Step 1: Select a frequency operational mode. A frequency operational mode can be selected from a plurality of frequency modes by the user or based on a predetermined setting. In one embodiment, the frequency operational mode is used for setting a variation tolerance, i.e. an operational frequency range in which the processing device can be automatically adjusted by itself. In another embodiment, the user is capable of directly assigning a desired frequency range.

Step 2: Set a frequency range according to the frequency operational mode. A frequency range of the selected frequency operational mode in Step 1 is determined. For example, in one embodiment, if a frequency operational mode with 5% deviation is selected, the range will be adjusted to a frequency range from 400 MHz to 420 MHz in a 400 MHz operational frequency of a processing device. In addition, in another embodiment, the upper threshold and the lower threshold of the frequency range are directly determined according to input values from the user.

Step 3: Select an operational frequency within the frequency range for running the digital processing device. In one embodiment, the processing device can automatically select a proper frequency from the frequency range of 400 MHz to 420 MHz. If it needs more system resources to execute heavy loading such as playing 3D program, 420 MHz will be selected as the operational frequency by the digital processing device . If in standby status, the operational frequency will be assigned as 400 MHz .

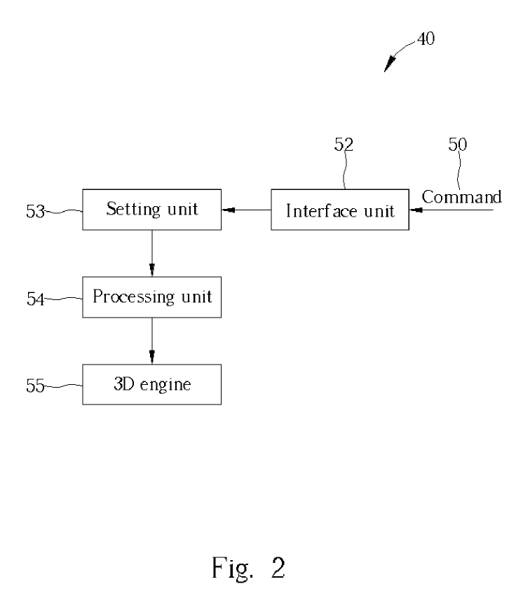

Please refer to FIG. 2, which shows a block diagram of the system 40 according to the present invention. The system 40 comprises an interface unit 52, a setting unit 53 and a processing unit 54. The interface unit 52 is used for receiving an external command 50, so that the user is capable of determining the frequency operational mode by means of the interface unit 52. In one embodiment, the frequency operational mode can be a tolerance percentage of over clocking the suggested operational frequency, such as 5%. In another embodiment, the frequency operational mode can assign the highest and the lowest operational frequency based on the user's requirement. The setting unit 53, coupled to the interface unit 52, is used for determining a frequency range based on the selected frequency operational mode. The processing unit 54, coupled to the setting unit 53, is used for selecting an operational frequency within the frequency range based on the requirement. If a heavy job is performed, the processing unit 54 selects a higher frequency so as to increase performance. If in standby mode, the processing unit 54 selects a lower frequency for stability. In one embodiment, due to 3D programs requiring a large amount of data calculation, the processing unit 54, couple to a 3D engine 55, is capable of detecting if the 3D engine 55 has been activated and determining the optimal operational frequency based on the detecting result.

In one embodiment, the setting unit 53 and the processing unit 54 can be integrated. This means the setting unit 53 can be built within the processing unit 54 .

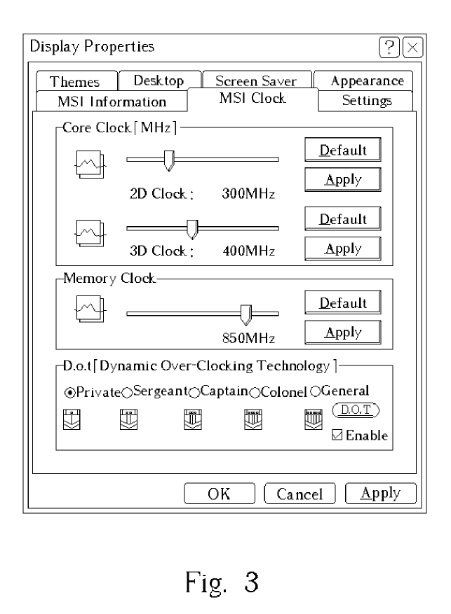

Please refer to FIG. 3, which is a graph showing the manipulation interface according to the present invention. This embodiment is a software format that is used for adjusting the operational frequency of a GPU in a VGA card. Typically, the operational frequency of the GPU can be adjusted by changing a core clock, a memory clock or both of them. As shown in an upper part of FIG. 3, the operational frequency can be selected by the users assignation or a predetermined value. The GPU is operated under the assigned operational frequency until the user assigns another one. As shown in a lower part of FIG. 3, a dynamic over-clocking technology (DOT) block is an embodiment of the interface unit 52, with which the user can determine if enable the dynamic over-clock function. If the user wishes to enable the dynamic over-clock function, the user clicks an “Enable” block and then selects a desired mode from five different frequency ones corresponding to different over-clock scales, for instance, a Private mode for 2% over-clock, a Sergeant mode for 4% over-clock, a Captain mode for 6% over-clock, a Colonel mode for 8over-clock, and a General mode for 10% over-clock. If the user does not select any mode, a predetermined setting which may be the Private mode is assigned . The GPU can select an optimal operational frequency for improving performance according to the assigned variation tolerance. In addition to software format, a hardware circuit, or firmware format also can achieve the same purpose of the present invention also belongs to the scope of the present invention.

In summary, the user can set a frequency range, so that a digital processing device can automatically determine an optimal frequency from the frequency range, which provide higher performance when processing heavy jobs and running at normal speed for stability when processing simple jobs.

Those skilled in the art will readily observe that numerous modifications and alterations of the device may be made while retaining the teachings of the invention. Accordingly, the above disclosure should be construed as limited only by the metes and bounds of the appended claims.

1. A method for dynamically adjusting an operational frequency of a digital processing device comprising:
selecting a frequency operational mode;
setting a range of operational frequencies according to the frequency operational mode; and
selecting an operational frequency within the frequency range for running the digital processing device.

2. The method of claim 1, wherein the frequency operational mode is used for assigning a variation tolerance of the operational frequency.

3. The method of claim 1 being performed in a video graphics adapter (VGA).

4. The method of claim 1 capable of being used for adjusting the operational frequency by changing a core clock, a memory clock or both of them.

5. The method of claim 1 being performed in a central processing unit (CPU).

6. A method for dynamically adjusting an operational frequency of a digital processing device comprising:
(a) setting a frequency range; and
(b) selecting an operational frequency in the frequency range for running the digital processing device.

7. The method of claim 6, wherein step (a) further comprises:
(a1) selecting a frequency operational mode; and
(a2) setting a range of operational frequencies according to the frequency operational mode.

8. The method of claim 7, wherein the frequency operational mode is used for assigning a variation tolerance of the operational frequency.

9. The method of claim 6 being performed in a video graphics adapter (VGA).

10. The method of claim 6 capable of being used for adjusting the operational frequency by changing a core clock, a memory clock or both of them.

11. The method of claim 6 being performed in a central processing unit (CPU).

12. The method of claim 6 further comprising determining being enabled by a user.

13. A system for dynamically adjusting an operational frequency of a digital processing device, comprising:
an interface unit for receiving an external command to select a frequency operational mode;
a setting unit, coupled to the interface unit, for setting a frequency range according to the frequency operational mode; and
a processing unit, coupled to the setting unit, for selecting an operational frequency in the frequency range.

14. The system of claim 13, wherein the frequency operational mode is used for assigning a variation tolerance of the operational frequency.

15. The system of claim 13, wherein the operational frequency is capable of being adjusted by changing a core clock, a memory clock or both of them.

16. The system of claim 13 capable of determining being enabled by a user.

17. The system of claim 13, wherein the setting unit is built within the processing unit.
